(19) United States
(12) Patent Application Publication
(10) Pub. No.: US 2008/0169721 A1
(43) Pub. Date: Jul. 17, 2008

(54) Motor

(76) Inventor: Ho Jae Lee, Gimhae-si (KR)

Correspondence Address: MCKENNA LONG & ALDRIDGE LLP, 1900 K STREET, NW, WASHINGTON, DC, 20006, US

(21) Appl. No.: 11/652,040

(22) Filed: Jan. 11, 2007

(51) Int. Cl. H02K 1/12; H02K 1/24

(52) U.S. Cl. 310/216; 310/254

(57) ABSTRACT

A motor has a stator and a rotor that rotates about the stator, wherein the stator includes, a stator core in which a magnetic flux path is formed; a plurality of teeth projected in a radial direction of the stator core; a pole shoe that extends in a circumferential direction of both opposite ends of the tooth; and a cogging torque reduction part formed on the pole shoe to prevent a drastic change of a magnetic pole, such that cogging torque is minimized.

This application claims the benefit of PCT application No. PCT/KR2006/005392 filed on Dec. 11, 2006 and the Korean Application No. 10-2005-0073673 filed on Aug. 11, 2005, both of which are hereby incorporated herein by reference.

### BACKGROUND OF THE INVENTION

1. Field of the Invention

The present invention relates to a motor, more particularly, to a motor that is easily fabricated with enhanced efficiency and durability, which has a compact structure to be convenient to a user.

2. Background of the Related Art

In general, a shading coil motor is used in a refrigerator or a freezer as a fan motor. A shading coil as well as a main coil is wound around a stator of the shading coil motor.

The shading coil is configured to start a rotor. The shading coil, together with the main coil, forms an oval shaped magnetic field to start a rotor. When the rotor is rotating, the shading coil is not needed and wastes electricity.

Moreover, auxiliary teeth should be provided to wind the shading coil, and thereby make a shape of the stator complex, and the shading coil should be additionally wound around the teeth, and thereby makes the winding complex.

Because the shading coil motor uses a 1-phase alternating current power to reduce the number of electric and electronic parts, the shading coil motor has an advantage of low cost. However, generally the shading coil motor consumes and wastes a lot of electricity.

Also, it is difficult to control the shading coil motor and it has a further disadvantage due to its large size.

Thus, demands for a motor, which can reduce electricity consumption with a compact exterior that can be easily fabricated, have been increasing. The motor may not just operate a fan but appropriately control a fan speed and torque.

### SUMMARY

An object of the present invention is to provide a motor capable of being easily fabricated with a compact exterior by reducing a motor mounting space, such that the motor may have broad applications.

Another object of the present invention is to provide a motor that enhances efficiency by minimizing electricity loss.

A further object of the present invention is to provide a motor that can control its rotational speed or torque to enhance reliability and durability. According to various embodiments of the present invention, cogging torque is reduced to enhance the efficiency of the motor such that the motor may be controlled more smoothly.

To achieve these objects and other advantages and in accordance with the purpose of the invention, as embodied and broadly described herein, a motor comprises a stator core that forms a magnetic path and has a plurality of tooth parts along a circumferential direction; a tooth provided in each tooth part to wind a coil there around; and an extension part alternated with the tooth part along a circumferential direction of the stator core, extending to an inner radial direction.

Here, the extending part secures an enough space for a magnetic flux to flow, such that efficiency of the motor is enhanced. Also, the extending part may convexly extend to the tooth part and may improve the strength of the stator core.

A plurality of unit stator cores may be multi-layered to form the stator core. In other words, the unit stator cores may be multi-layered in a direction of a shaft, that is, a longitudinal direction. This multi-layered structure can minimize a leakage flux, which may be generated in a direction perpendicular to a flux direction, such that efficiency of the motor is improved.

By the way, a caulking part may be formed to fasten the multi-layered unit stator cores as one body. The caulking part may prevent the efficiency of motor from deteriorating. Preferably, the caulking part is formed on the extending part to prevent the structural strength of the stator core from weakening. The caulking part is formed on the extending part having an enough predetermined thickness. It is preferred that the caulking part is formed on a center of the extending part that has the greatest thickness.

The tooth may be formed as one body with the stator core. When a unit stator is blanked and formed, the tooth also may be formed. Alternatively, the tooth may be separately formed from the stator core and then fastened to a tooth part. That is, an end of the tooth is inserted in a tooth slot formed on the tooth part to fasten the tooth to the tooth part.

Also, a groove may be further formed on an outer portion of the tooth part. The groove is formed in a longitudinal direction of the stator core to separate the stator core, that is, the unit stator cores from a blank mold easily.

The groove may correspond to the tooth slot and especially to a center of the tooth slot. In other words, if the tooth slot is formed on a portion within the stator core, it is preferred that the groove is formed on an outer portion of the stator core on which the tooth slot is formed. The groove may minimize variation of the stator core size generated in the tooth's being inserted in the tooth slot.

By the way, the stator may further include a bobbin. The tooth is inserted in a center of the bobbin and a coil is wound around the bobbin. The bobbin insulates electricity between the tooth and the coil and fixes the coil securely.

More specifically, the bobbin includes an inner wall and an outer wall to prevent the coil from separately going out. The outer wall may be in contact with the tooth part and an inner wall of the tooth part is plate-shaped to fix the bobbin more securely.

The motor may be a BLDC motor.

More specifically, the motor includes a stator and a rotor that rotates about the stator. The stator comprises a stator core having a plurality of tooth parts formed along a circumference, in which a magnetic flux path is formed; a plurality of teeth provided on the tooth parts to be wound around by a coil; and an extending part convexly extending toward an inner radial direction, alternated with the plurality of tooth parts. The rotor has a permanent magnet to alternatively magnetize magnetic poles along an outer circumferential surface of the rotor. The extending part is formed on every portion between two neighboring tooth parts.

Various embodiments of the present invention may comprise a cogging torque reduction part. That is, the stator of the motor comprises a stator core in which a magnetic flux path is formed; a plurality of teeth projected in a radial direction of the stator core; a pole shoe having both opposite ends extending in a circumferential direction to be substantially parallel with the rotor; and a cogging torque reduction part formed on the pole shoe to prevent a drastic change of a magnetic pole, such that cogging torque is minimized.

The cogging torque reduction part may be formed at an end of the pole shoe in a circumferential direction.

The cogging torque reduction part may be a side or both opposite sides of the pole shoe's end.

The cogging torque reduction part may reduce density of a magnetic flux. Reducing density of a magnetic flux in a portion where polarity changes may prevent polarity from changing drastically. In other words, the air gap increases to prevent a polarity from changing drastically, related to a permanent magnet of the rotor. For example, the width of the pole shoe where the cogging torque reduction part is formed is reduced for that. The cogging torque reduction part may be a cut part longitudinally cut to have a width narrower than the width of the other portions of the pole shoe. Here, the longitudinal direction means a shaft direction.

Preferably, the cut part extends an air gap between the tooth and the rotor. That is, the cut part is formed on a portion of the pole shoe that faces the rotor.

Therefore, various embodiments of the present invention have following advantageous effects.

First, the motor may be fabricated without difficulties and the exterior of the motor is compact. Thus, there is an advantageous effect in that space for the motor may be reduced to expand the area to which the motor is adapted.

Second, the motor reduces a leakage flux. Thus, there is another advantageous effect in that motor efficiency is enhanced with least electricity loss.

Third, the motor has a further advantageous effect in that it can minimize vibration due to reducing cogging torque and control the rotational speed of the shaft and torque smoothly.

Finally, the motor may prevent malfunctions which might be generated in the fabrication process or usage. Thus, there is a further advantageous effect in that a motor having high reliability as well as high durability may be provided.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 is an exploded perspective view illustrating a motor according to an embodiment of the present invention;

FIG. 2 is a perspective view illustrating some parts of the motor shown in FIG. 1 that are assembled;

FIG. 3 is a perspective view illustrating a down surface of an upper bracket shown in FIG. 1;

FIG. 4 is a plane view illustrating a lower bracket of FIG. 1 that is fastened to a PCB;

FIG. 5 is a plane view illustrating a stator of FIG. 1;

FIG. 6 is a plane view partially illustrating a fixing structure of a conventional connector for power connection; and

FIG. 7 is a perspective view partially illustrating a fixing structure of a connector for power connection to the motor according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

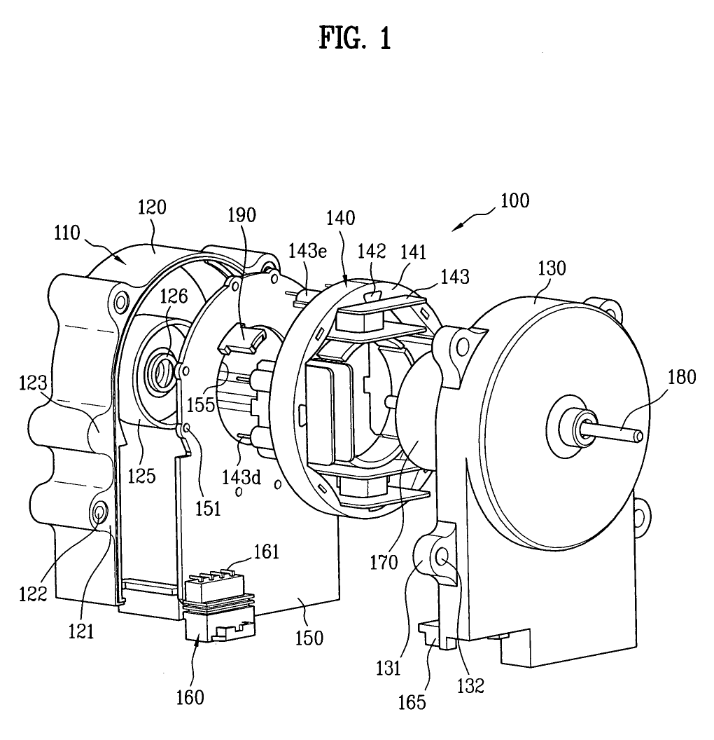

FIG. 1 is an exploded perspective view of a motor 100 according to an embodiment of the present invention.

As shown in FIG. 1, the motor includes a bracket 110, a PCB 150, a stator 140, a rotor 170 and a shaft 180. The bracket 110 defines an exterior of the motor. The PCB 150 is held within the bracket 110 and has a circuit pattern (not shown). Also, various elements (not shown) are mounted in the PCB 150.

The bracket 110 includes a lower bracket 120 and an upper bracket 130. The lower and upper brackets 120 and the 130 are coupled to each other to hold various components therein. To couple the lower and upper brackets 120 and 130 to each other, a fastening boss 121 and 131 may be fastened through a fastening hole 122 and 132 formed on the fastening boss 121 and 131 using a screw (not shown).

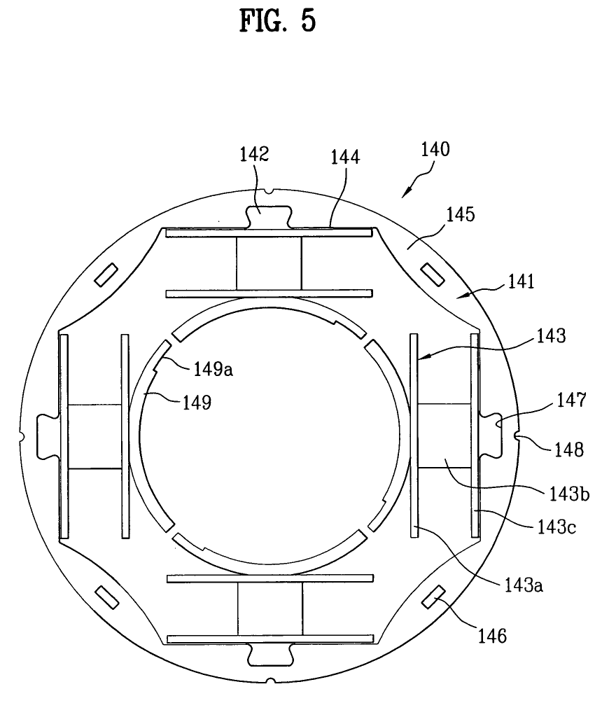

Referring to FIGS. 1 and 5, the stator 140 of the motor will be described in detail.

The stator 140 includes a stator core 141 and a tooth 142.

As shown in the above drawings, the stator core 141 may be formed in a circular shape and forms a magnetic path. The tooth 142 is projected in a radial direction of the stator core 141 and a coil is wound around the tooth 142. The motor shown in the drawings is embodied as an inner rotor type motor in which a rotor is provided within a stator core 141. Thus, the tooth 142 is projected inwardly in a radial direction. A plurality of teeth 142 may be formed and FIG. 5 shows that four of the teeth 142 are formed.

A plurality of tooth parts 144 are alternated with a plurality of extending parts 145 along an inner circumferential direction of the stator core 141. Here, the teeth 142 are provided on the tooth parts 144, respectively. The extending part 145 is extending convexly and inwardly in a radial direction.

The extending part 145 may be extending inwardly and convexly between two neighboring tooth parts 144 in a radial direction. Preferably, the extending part 145 increases its thickness entirely to secure enough space needed in forming a magnetic flux. Thereby, a leakage flux due to a high saturation on flux density is minimized to maximize an efficiency of the motor, and the thickness of the stator core 141 increases to reinforce a structural strength of the stator core 141.

Alternatively, the extending part 145 may be formed outwardly in a radial direction. But, this may enlarge the size of the stator core 141, and thereby enlarge the entire size of the motor.

The stator core 141 may be formed by multi-layering a plurality of unit stator cores. That is, a plurality of thin unit stator cores may be multi-layered to form a stator core 141 having a predetermined height. The stator core 141 formed by the multi-layered unit stator cores may minimize a leakage flux, which may be formed in a perpendicular direction of the magnetic flux, to enhance efficiency of the motor. It is also preferred that the teeth 142 are formed by a multi-layering method.

If the stator core 141 is formed by multi-layering the unit stator cores, the stator cores 141 may be fastened to each other as one body. This means that the one stator core 141 formed as one body is necessary. Thus, a caulking part 146 may be provided to fasten the stator cores 141 to each other. The caulking part 146 is formed on the stator core 141, more specifically, a portion having a wide width. The caulking part 146 passes through an upper and lower part of the stator core 141 to minimize a leakage flux or a fringing flux due to the caulking part 146.

The caulking part 146 may be formed on the extending part 145. Preferably, the caulking part 146 is formed on a center of the extending part 145, which has the widest width.

Thereby, it is possible to perform secure caulking. The caulking part 146 may minimize distortion of the stator core 141 and may prevent efficiency deterioration.

Meanwhile, the teeth 142 may be formed as one body with the stator core 141, that is, the teeth 142 may be formed as one body with the stator core 141 from the beginning. Alternatively, the teeth 142 are formed separately from the stator core 141 and fastened to the stator core 141 to make easy the fabrication of the stator 140 as well as its winding.

A tooth slot 147 is formed at a center of the tooth part 144 formed on the stator core 141 and an end of the tooth 142 is inserted in the tooth slot 147 to fasten the tooth 142 to the stator core 141.

Thus, a tooth 142 is inserted in a bobbin 143 and a coil is wound around the bobbin 143 to insert the tooth 142 in the tooth slot 147, such that the fastening between the bobbin 143 and the tooth 142 and winding may be smooth.

Next, a groove 148 may be formed on an outer circumferential surface of the stator core 141 in a longitudinal direction of the stator core 141. Preferably, a plurality of grooves 148 may be formed along circumferential direction of an outer surface of the stator core 141.

The groove 148 also helps the unit stator cores to separate from a blanking mold when the unit stator cores are blanked and molded. More specifically, the groove 148 makes the internal pressure of the mold same as the external pressure to smoothly separate the unit stator cores from the mold. Furthermore, the groove 148 guides the unit stator cores.

It is preferred that the groove 148 is formed on an outer portion of the tooth part 147 formed on the stator core 141 to minimize variation of core size caused when the tooth 142 is inserted in the tooth slot 147. Thus, to perform this function, it is preferred that the groove 148 may correspond to a center of the tooth slot 147.

It is preferred that a coil is wound around the bobbin 143 configured for insulation so that winding between a coil and the tooth 142 is done without any difficulties, instead of directly winding a coil around the tooth 142.

The bobbin 143 may be configured as an inner wall 143a, a winding part 143b and an outer wall 143c. A coil is wound around the winding part 143b between the inner wall 143a and the outer wall 143c, and the inner wall 143a and the outer wall 143c prevent the coil from coming outside.

Here, the outer wall 143c of the bobbin 143 contacts with the tooth part 144 provided on the stator core 141. Preferably, an inner wall of the tooth part 144 is plane to be contacted with the outer wall 143c of the bobbin 143, such that the bobbin 143 may be coupled to the stator core 141 more securely.

By the way, the motor may have four teeth 142, for example, as shown in FIG. 5. Hence, if power is applied to the coil wound around the tooth 142, an N-pole and an S-pole are alternatively formed on each tooth 142. As shown in FIG. 5, if an N-pole is formed on a tooth 142 provided on most upper position, an S-pole is formed on neighboring teeth.

Polarity is formed on the teeth 142 and a leakage flux increases as the distance between the teeth is getting farther and farther. Thus, a pole shoe 149 may be formed on a front end of each tooth 142 to minimize a leakage flux and to extend a predetermined length in both opposite circumferential directions to be fixedly contacted with an outer surface of the rotor 170. Thereby, a leakage flux caused between the two neighboring teeth may be minimized.

As shown in FIG. 5, the pole shoe 149 formed on one tooth 142 may not be connected to the next pole shoe 149 formed another neighboring tooth 142. This is because two different polarities are formed on two neighboring pole shoes 149, respectively. Thus, if the two neighboring pole shoes 149 are connected, polarity may deteriorate.

Together with the pole shoe 149 formed to minimize a leakage flux, it is preferred to reduce cogging torque or torque ripple generated from the shaft 180 and the rotor 170 by drastic change of polarity between teeth. This is because it is better to increase the air gap to prevent a polarity from changing drastically, related to a permanent magnet of the rotor 170.

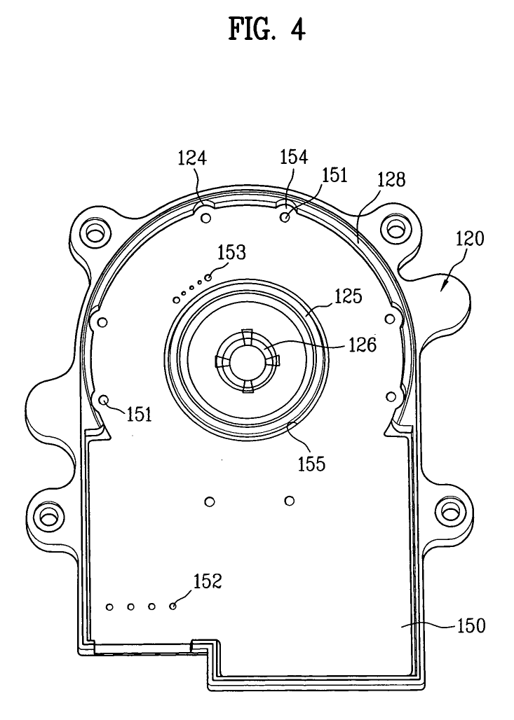

Next, referring to FIGS. 1 and 4, a PCB 150 of the motor according to an embodiment of the present invention will be described. FIG. 4 is a plane view illustrating that the PCB 150 is seated on a lower bracket 120.

As shown in FIGS. 1 and 5, the stator 140 may be formed in a circular shape. Corresponding to the shape of the stator 140, at least some portion of the PCB 150 may be formed in a circular shape. As shown in FIGS. 1 and 4, an upper portion of the PCB 150 may be formed in a circular shape, where the stator 140 is seated.

A radius of the circular portion of the PCB 150 may be substantially same as that of the stator core 141. A large sized exterior of the PCB 150 may enlarge the size of the bracket 110. Hence, the entire size of the motor may be large. Accordingly, some portion of the PCB 150 may be formed in a circular shape to provide a compact sized motor.

Furthermore, since the shape of the bracket 110 corresponds to shape of the PCB 150, exterior beauty of the motor may be enhanced.

By the way, fin 143d is formed on a lower both opposite sides of the bobbin 143. The fin 143d is electrically connected to the coil wound around the bobbin 143. Thus, the fin 143d is inserted in a hole 151 formed on the PCB 150 to connect the PCB 150 to the coil. Once the fin 143d is inserted in the hole 151 of the PCB 150, soldering may be performed for secure electrical connection.

The fin 143d helps the stator 140 to seat on an upper portion of the PCB 150 by using the bobbin 143, as well as electrically connect the PCB 150 to the coil. Thus, the fin 143d is formed on the boss 143e to enlarge a contact section with the PCB 150 and to carry the weight of the stator 140.

The boss 143e is formed in a lower portion of the outer wall 143c to maintain a distance between the PCB 150 and the stator core 141.

By the way, a connector 160 is provided on a side of the PCB 150. A fin 161 is formed on an end of the connector 160 and the connector 160 is fixed to the PCB 150 through the fin 161, to electrically connect to the PCB 150. The fin 161 is inserted in a hole 152 formed on the PCB 150 and the other end of the connector 160 is exposed outside of the motor, that is outside of the bracket 110, to be connected to an external power.

Furthermore, a hall sensor assembly 190 is provided on a portion of the PCB 150 corresponding to the position of the rotor 170. The hall sensor assembly 190 senses a rotation position or a rotational speed of the rotor 170 to control a rotation speed or torque of the rotor 170. Thus, a hole 153 is formed on the PCB 150 to fix the hall sensor assembly 190 and to electrically connect the hall sensor assembly 190 to the PCB 150.

Because four teeth 142 are provided in the motor of this example, four portions to which four bobbins 143 are coupled are provided.

As shown in FIGS. 1 and 4, some portion of the PCB 150 is formed in a circular shape. A predetermined number of the four portions are formed on a circular shaped portion of the PCB 150. As described above, this circular shaped portion is corresponding to the circular shape of the stator 140.

To provide a motor having a compact size by lessening the size of the PCB 150, a predetermined number of holes 151 may be formed on an outermost portion of the circular shaped PCB portion. That is, a predetermined number of holes 151 may be formed on a circumference of the PCB 150. Because the strength of the portion having the holes 151 formed thereon may weaken, there may be a malfunction when forming the holes 151, or there may be damage to the holes 151 due to vibration and the like.

For this, it is preferred that an extending part is extended outwardly on a portion in which every hole 151 is formed. In other words, the extending part 154 secures a predetermined distance between the holes 151 and the outermost portion of the PCB 150, such that the strength of the PCB 150 is reinforced and the external shape of the PCB 150 is prevented from getting large. Furthermore, the extending part 154 enables the PCB 150 to be seated on the bracket 110 smoothly.

A hollow portion 155 may be formed on the PCB 150. The hollow portion 155 may be formed on a center of the PCB 150 and a stopper, which will be described later, is inserted in the hollow portion 155 to prevent interference between the rotor 170 and the PCB 150.

Also, because the stopper is inserted in the hollow portion 155, the PCB 150 may be securely fixed to the bracket 110.

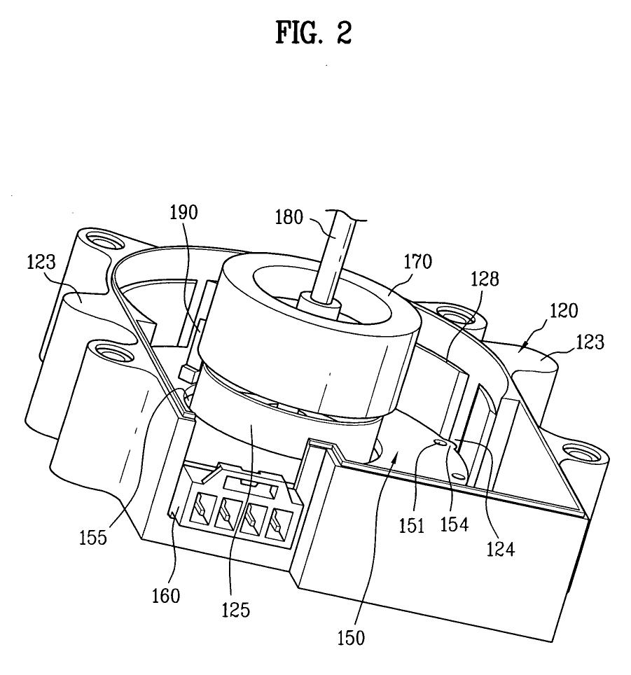

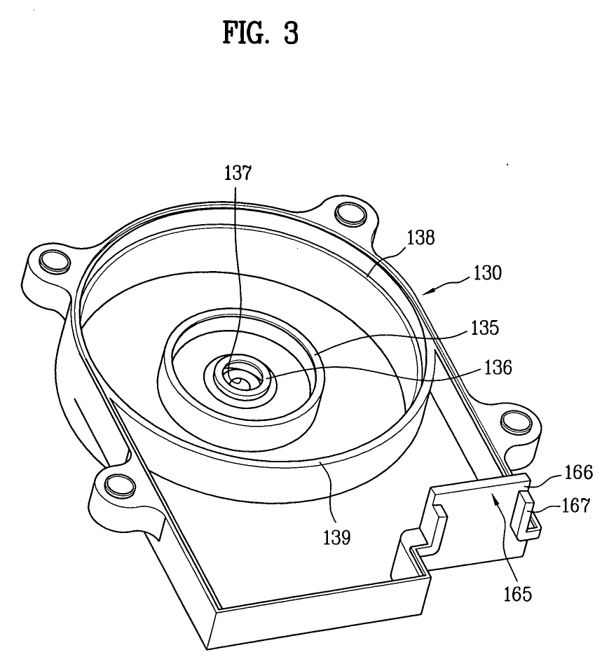

Next, referring to FIGS. 2 and 3, the bracket 110 of the motor according to an embodiment of the present invention will be described in detail.

As mentioned before, the bracket 10 includes a lower bracket 120 and an upper bracket 130 coupled to each other to hold various components. The lower bracket 120 may include a mounting part 123 that mounts the motor 100 to various parts the motor is applied to.

The shape of the bracket 110 corresponds to that of the PCB 150. The PCB 150 is seated within the bracket 110, more specifically within the lower bracket 120.

A groove 124 corresponding to the extending part 154 may be formed on the lower bracket to seat the extending part 154 therein. This can make the position of the PCB 150 to be automatically aligned when the PCB 150 is seated on the lower bracket 120, and even more securely.

A step part 128, which will be described later, may be formed on the lower bracket 120 to mount the stator to the lower bracket 120. The step part 128 is projected a predetermined distance from an inner wall of the lower bracket 120. Preferably, the groove 124 cuts into some portion of the step part 128 to prevent the shape of the bracket from becoming large due to the groove 124.

As shown in FIG. 2, the PCB 150 is mounted within the lower bracket 120. As described above, a stopper 125 is inserted in the hollow portion 155 formed on the PCB 150.

Hence, the stator 140 is imparted on the PCB 150, and the rotor 170 and the shaft 180 are provided within the stator 140.

An end of the shaft 180 is rotatably supported by the bearing 126 provided in the lower bracket 120 and a thrust is supported, too. The other end of the shaft 180 is rotatably supported by the bearing 136 provided in the upper bracket 120. Here, the shaft is exposed outside through the through hole 137 to drive load.

The shaft 180 may be inserted in the rotor 170 to rotate as one body with the rotor 170, such that the rotor 170 is prevented from moving in a longitudinal direction of the shaft 180. This is shown in FIG. 2.

However, the rotor 170 may move in a longitudinal direction of the shaft due to vibration. This may cause interference between the rotor 170 and the PCB 150 and damage the PCB 150.

Due to those problems, a stopper 125 may be formed and prevents the rotor 170 from moving toward the shaft 180. The stopper 125 may project from an inside of the bracket and may be formed as one body with the bracket.

The stopper 125 formed as one body with the lower bracket is shown in FIGS. 1 and 2.

Preferably, a stopper 135 may be formed in the upper bracket 130 as one body with the upper bracket 130, too. The rotor 170 may be provided between the both stoppers 125 and 135.

Thus, the stopper 125 and 135 can prevent interference between the bracket 110 and the PCB 150 even though the rotor 170 may move toward the shaft 180.

The stopper 125 and 135 may be projected in a cylindrical shape. This is because it is preferred that the stopper corresponding to the rotor 170 have a cylindrical shape. Also, an upper surface of the stopper 125 and 135 is contacted with an upper or lower surface of the rotor 170. An outer or inner diameter of the stopper 125 and 135 may be determined for that.

The stator 140 is securely fixed within the bracket 110. For this, a step part 128 and 138 is formed on a lower and upper bracket 120 and 130, respectively.

The stator 140, more specifically an outer circumferential surface of the stator core 141, is seated on the step part 128 and 138. Hence, as the upper bracket 130 is coupled to the lower bracket 120, the stator 140 is securely fixed between the step parts 128 and 138.

Because the PCB 150 has been already seated on the lower bracket 120, it may be difficult to form the step part 128 corresponding to the entire circumference of the stator core 141. Thus, the step part 138 may be formed corresponding to the entire circumference of the stator core 141. For this, it is preferred that an inner partition wall 139 is further formed within the upper bracket 130.

Alternatively, an inner partition wall may be formed in the lower bracket, too. If so, a through hole (not shown) should be formed on the PCB 150 so that the inner partition wall may pass there through. Thereby, this may not be preferred.

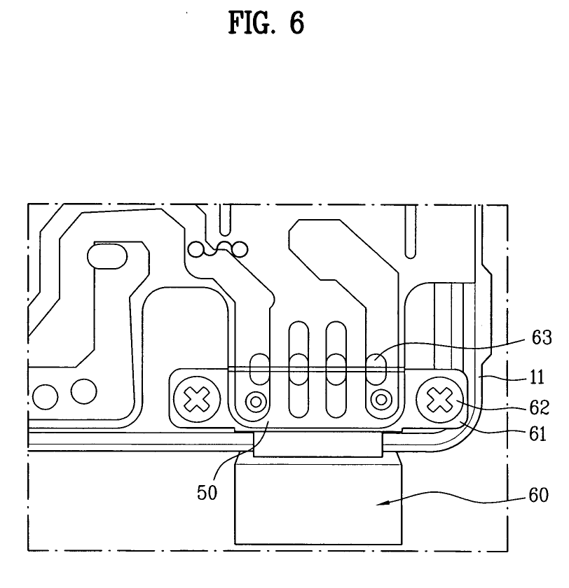

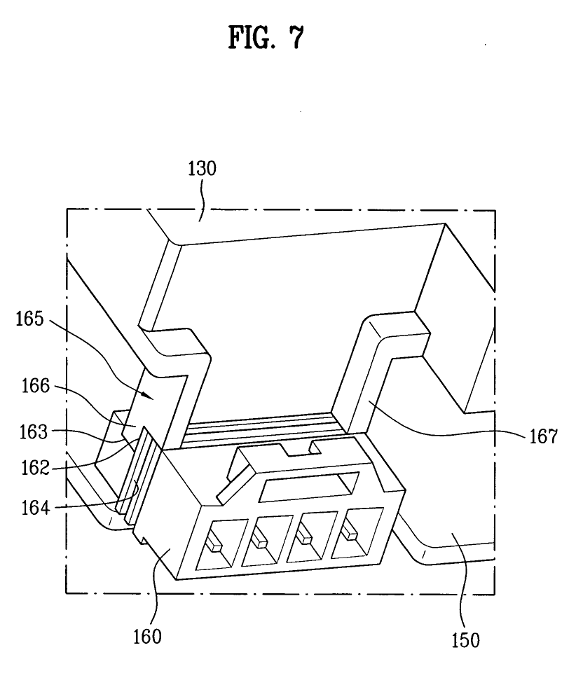

Next, referring to FIGS. 6 and 7, a connector for power connecting of the motor will be described.

FIG. 6 is a front view illustrating a fixing structure of a conventional connector and FIG. 7 is a partial perspective view illustrating a fixing structure of a connector according to an embodiment of the present invention.

The function of the conventional connector 60 is same as that of the connector 160 according to the embodiment of the present invention. More specifically, the connector 60 supplies the power to the PCB 50. An end of the connector 60 is connected to the PCB 50 and the other end of the PCB 50 is exposed outside of the bracket to be connected to an external power.

Here, the other end of the connector 60 is connected to an external power via a plug (not shown) and the connector 60 is subject to a lot of force when the plug is connected or separated.

The force may be a force that pushes the connector 60 into the bracket or a force that pulls the connector 60 out of the bracket.

The connector 60 is electrically connected to the PCB 50 via the soldering 63 but this connection part may be damaged by the above-mentioned external force. Thus, the external force that influences the connection part between the PCB 50 and the connector 60 has to be minimized.

For this, a wing part 61 extends in both opposite sides of the conventional connector's center, respectively. An opening (not shown) is formed on the wing part 61. Also, a boss (not shown) having a fastening hole corresponding to the opening is formed on the bracket 11.

Thus, once the connector 60 is connected to the PCB 50, the wing part 61 of the connector 60 is fastened to the boss of the bracket 11 through a screw 62. Because the wing part 61 absorbs the external force, the connection part between the connector 60 and the PCB 50 may be prevented from damaging.

However, according to a conventional structure, the size of the connector can become large and complicated. As shown in FIG. 6, the portion of the PCB 50 where the wing part 61 is formed should be cut. Also, if auxiliary screw fastening is needed this will cause productivity to decrease if motors should be fabricated in mass. There is a problem that the number of necessary parts may increase, as well.

Therefore, according to the motor of the embodiment of the present invention, the motor further includes a reinforcing part formed as one body with the upper bracket or the lower bracket to reinforce a fixing strength of the connector as the upper bracket is coupled to the lower bracket.

That is, an auxiliary part such as a screw is not needed to reinforce the fixing strength of the connector and the coupling of the upper and lower bracket may automatically reinforce the fixing strength, thereby allowing for an easier fabrication process.

FIG. 7 illustrates that a reinforcing part is formed as one body with an upper bracket.

The reinforcing part 165 may be a side wall of the upper bracket 130 and may include a projection rib 166 projected toward the connector 160. Alternatively, the projection rib 166 may be separate from a side wall of the upper bracket 130.

A stepped part 162 may be formed on the connector 160 for the projection rib 166 to be in contact with. Since the projection rib 166 is in contact with the step part 162, an external force generated from the connector 60 may be absorbed.

The contacting process between the projection rib 166 and the step part 162 is performed simultaneously together with the coupling process between the upper and lower bracket. Thereby, the conventional process of screw fastening may be omitted.

The step part 162 absorbs only the force that pushes the connector 160 into the bracket. Thus, the step part 162 may be formed as a groove part 163 to absorb the force that pulls connector 160 out of the bracket 110, as well. The projection rib 166 is inserted in the groove part 163 to absorb the force of both directions.

The reinforcing part 165 may further include a reinforcing rib 167 to reinforce the strength of the projection rib 166. The reinforcing rib 167 may be formed on an inner and outer portion of the bracket, respectively.

Alternatively, the reinforcing rib 167 may be perpendicular to the projection rib 166. Here, it is preferred that some portion of the reinforcing rib 167 is in contact with an upper surface of the connector 160. This is because the connector 160 can be securely fixed by the increase of the section in contact with the upper bracket 130 and the connector 160.

Furthermore, a groove 164 may be formed on an outer circumferential surface of the connector 160 in a horizontal direction to securely fix the connector 160.

Some portion of the lower bracket 120 is inserted in the groove 164 to reinforce the fixing strength of the connector.

It will be apparent to those skilled in the art that various modifications and variations can be made without departing from the spirit or scope of the invention. Thus, it is intended that the present invention cover the modifications and variations provided that they come within the scope of the appended claims and their equivalents.

Therefore, the motor has a following industrial applicability

First, the motor may be fabricated without difficulties and the exterior of the motor is compact. Thus, there is an advantageous industrial applicability that space for the motor may be reduced to expand the area to which the motor is adapted.

Second, the motor may reduce a leakage flux. Thus, there is another advantageous industrial applicability that motor efficiency is enhanced with least electricity loss.

Third, the motor has a further advantageous industrial applicability in that it may minimize vibration due to reducing cogging torque and may control the rotational speed of the shaft and torque smoothly.

Finally, the motor may prevent malfunctions which may be generated in the fabrication process or usage. Thus, there is a further advantageous industrial applicability that a motor having high reliability as well as high durability may be provided.

1. A motor having a stator and a rotor that rotates about the stator, wherein the stator comprises,
a stator core in which a magnetic flux path is formed;
plurality of teeth projected in a radial direction of the stator core
a plurality of bobbins, each bobbin inserted in a corresponding tooth, wherein at least one bobbin includes a fin to electrically connect with a circuit board; and
a pole shoe that extends in a circumferential direction of both opposite sides of one end of the tooth.

2. The motor of claim 1, wherein both ends of the pole shoe extending in a circumferential direction are substantially parallel with the rotor.

3. The motor of claim 1, wherein the motor is an inner rotor type motor in which the teeth are projected inwardly in a radial direction of the stator core and the rotor is provided within the stator core.

4. The motor of claim 1, wherein the motor is a BLDC motor having a permanent magnet which alternatively magnetizes magnetic poles along a circumferential direction of the rotor.

5. The motor of claim 1, wherein the cogging torque reduction part is formed at an end of the pole shoe in a circumferential direction.

6. The motor of claim 5, wherein the cogging torque reduction part is formed only a first end of the pole shoe in a circumferential direction.

7. The motor of claim 1, wherein the cogging torque reduction part reduces density of a magnetic flux.

8. The motor of claim 7, wherein the cogging torque reduction part reduces a width of a pole shoe in which a magnetic flux is formed.

9. The motor of claim 7, wherein the cogging torque reduction part is a cut part longitudinally cut to have a width narrower than the other portions of the pole shoe.

10. The motor of claim 1, wherein the stator core and the plurality of teeth are formed as one body.

11. The motor of claim 1, wherein the stator core and the plurality of teeth are formed separately to be coupled, respectively.

12. The motor of claim 11, wherein an end of the tooth is inserted in a tooth slot formed on the stator core.

13. A motor comprising:
a stator core that forms a magnetic path and has a plurality of tooth parts along a circumferential direction;
a tooth provided in each tooth part to wind a coil there around; and
a cogging torque reduction part formed on a pole shoe extending in a circumferential direction of both opposite ends of the tooth, and having an extension part alternated with the tooth part along a circumferential direction of the stator core, extending to an inner radial direction.

14. The motor of claim 13, wherein unit stator cores are multi-layered to form the stator core.

15. The motor of claim 14, wherein a caulking part connecting the unit stator cores as one body is formed on the extending part.

16. The motor of claim 13, wherein an end of the tooth is inserted in a tooth slot formed on the tooth part.

17. The motor of claim 16, wherein a groove is formed on an outer portion of the tooth part in a longitudinal direction to minimize variation of a stator core size generated in inserting the tooth to the tooth slot.

18. The motor of claim 17 wherein the groove is corresponding to a center of the tooth slot.

19. The motor of claim 13, wherein the extending part is formed on every portion between two neighboring tooth parts.

20. The motor of claim 13, wherein the cogging reduction part is formed on an end of the pole shoe to reduce density of a magnetic flux.

21. The motor of claim 20, wherein the cogging reduction part is a cut part cut in a longitudinal direction to have a width narrower than the other portions of the pole shoe.

22. The motor of claim 21, wherein the cut part is formed by extending an air gap between the rotor and the pole shoe.
